(19) United States
(12) Patent Application Publication
(10) Pub. No.: US 2016/0097373 A1
(43) Pub. Date: Apr. 7, 2016

(54) MAGNETIC BEARING SYSTEMS

(71) Applicant: Vern Baumgardner, Twin Fall, ID (US)

(72) Inventor: Vern Baumgardner, Twin Fall, ID (US)

(21) Appl. No.: 14/508,273

(22) Filed: Oct. 7, 2014

(51) Int. Cl. F03D 11/00; F03D 3/00

(52) U.S. Cl. CPC F03D 11/0008; F03D 3/005

(57) ABSTRACT

A bearing system for application in a vertical axis wind turbine including: a first portion, where the first portion includes a threaded female end; a second portion, where the second portion includes a threaded male end, where the male end inserts into the threaded female end; and a cylindrical magnet, where the cylindrical magnet is embedded into a distal end of the opening.

### BACKGROUND OF THE INVENTION

1. Field of the Invention

The present invention relates to a magnetic bearing used to eliminate mechanical friction.

2. Description of Related Art

Bearings in general are used to transfer rotational forces over a rod, shaft or other rotating mechanical device. Bearings are used in various applications in axles, wheels and other rotating applications. The bearing usually enables the transfer of force over a particular area. One drawback of using bearings is the friction that inevitably occurs during use. This friction causes damage to the bearing and may necessitate the replacement thereof As a consequence, of it would be advantageous to have a device or design of a bearing that reduces frictional forces therefore increasing the useful life of a bearing.

### SUMMARY OF THE INVENTION

The present invention relates a bearing system for application in a vertical axis wind turbine comprising: a first portion, where the first portion includes a threaded female end; a second portion, where the second portion includes a threaded male end, where the male end inserts into the threaded female end; and a cylindrical magnet, where the cylindrical magnet is embedded into a distal end of the opening.

### BRIEF DESCRIPTION OF DRAWINGS

FIG. 1 depicts a magnetic bearing system in accordance with the present invention.

FIG. 2 depicts an application of the magnetic bearing in accordance with the present invention.

### DETAILED DESCRIPTION

The present invention relates to a magnetic bearing as used to reduce mechanical friction. The magnetic bearing in accordance with the present invention is used in conjunction with solar and wind power bearings. Rotational forces associated in particular with wind energy devices such as windmills have substantial forces placed upon bearings during use. The present invention provides an alternative bearing to use that eradicates mechanical friction by suspending the rotating turbines with magnetic components. The magnetic bearing system according to the present invention allows a lower cut in speed for electrical production without the need for repetition replacement and/or greasing of bearings. The magnetic bearing system of the present invention includes cylindrical magnets in the extended shaft and arc magnets on an outer housing to suspend and stabilize a rotating turbine for friction reduction. The present invention is designed with a round casing for the insertion of the outer magnets incorporated directly into a new design or existing inner hub of a vertical axle wind turbine as a aftermarket modification.

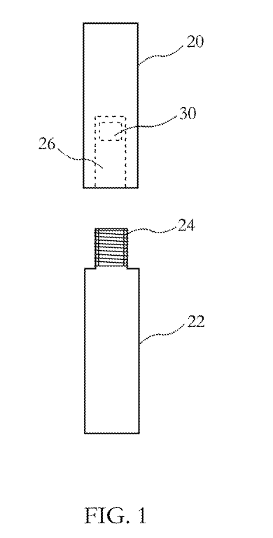

In reference to FIG. 1, a magnetic bearing system in accordance with the present invention is depicted. The magnetic bearing includes a first Portion 20 and a second Portion 22. The second Portion 22 includes a male threaded end 24, which is inserted into a threaded female Opening 26 within the first Portion 20. The threaded female Opening 26 includes a magnet 30 within embedded at a distal end of the Opening 26, as shown in FIG. 1.

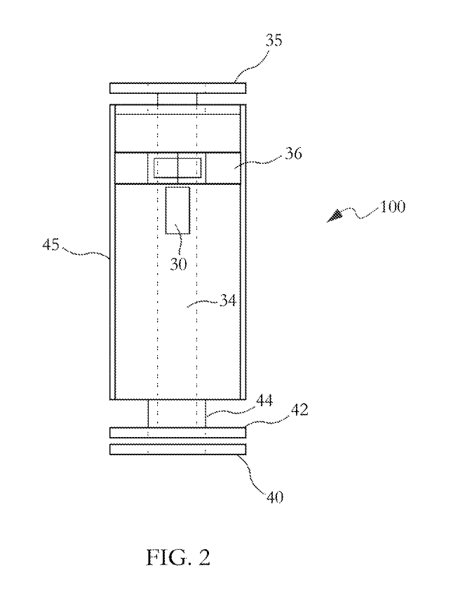

FIG. 2 depicts the cylindrical magnets used in conjunction with outer magnets to stabilize a center Shaft 34. The center Shaft 34 extends into an inner hub of a vertical axle turbine. The center Shaft 34 is shown going through the center of the inner hub and extends to a top end 35. The bottom end 42 is below the inner Hub 45. Also depicted in FIG. 2, the cylindrical Magnet 30 is positioned near the center of the center Shaft 34 within the inner Hub 45. This inner Hub 45 also includes a housing 36. The Housing 36 includes magnets 37 within the Housing 36 used in conjunction with the cylindrical Magnet 30. The magnetic rotation helps them manage friction within the inner Hub 45 and provides a suitable bearing system for the vertical axis wind turbine.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A bearing system for application in a vertical axis wind turbine comprising:
a. a first portion, where the first portion includes a threaded female end;
b. a second portion, where the second portion includes a threaded male end, where the male end inserts into the threaded female end; and
c. a cylindrical magnet, where the cylindrical magnet is embedded into a distal end of the opening.

2. An inner hub for use in a vertical axis wind turbine comprising:
a. a center shaft extending from a top end to a bottom end of the inner hub;
b. a cylindrical magnet positioned within the center shaft below a housing on the inner hub; and
c. a plurality of outer magnetics, where the outer magnetics are within the housing.
